(19) United States
(12) Patent Application Publication
(10) Pub. No.: US 2009/0121478 A1
(43) Pub. Date: May 14, 2009

(54) Male-Female member assembly

(76) Inventor: Satoshi Tsujita, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/092,700

(22) PCT Filed: Oct. 26, 2006
(86) PCT No.: PCT/JP2006/321357

§ 371 Date: May 5, 2008

(30) Foreign Application Priority Data
Nov. 4, 2005 (JP) 2005-321065

(51) Int. Cl. F16L 37/23

(52) U.S. Cl. 285/316

(57) ABSTRACT

In a female member 12 comprising a female member body 22 and a locking element retaining member 26 that is inserted and installed in the body to retain locking elements 24, it is made possible to install the locking elements 24 in all slits provided in the locking element retaining member 26, and it is also made easy to insert the retaining member into the female member body 22. The locking element retaining member 26 is provided with a plurality of circumferentially spaced locking element retaining slits 36 extending rearward from the forward end in the direction of insertion of the locking element retaining member into the female member body 22. Each locking element retaining slit receives a locking element from radially outside. The locking element is engaged and retained with both side wall surfaces 56 of the slit. The locking elements 24 retained in the slits are prevented from engaging an entrance opening surface 28, which forms a small-diameter portion, of a receiving bore 20 of the female member body when the locking element retaining member 26 is inserted and installed into the female member body 22.

### TECHNICAL FIELD

The present invention relates to male-female member assemblies such as a pipe coupling in which a male member is connected to a female member by inserting the former into the latter, and a holder designed to hold a desired member such as a panel by clamping it between a male member and a female member that are connected to each other.

### BACKGROUND ART

A widely known type of pipe coupling has a male member, a female member, and spherical locking elements installed in the female member. The male member is inserted into the female member, and the locking elements are fitted in an annular slit formed on the outer peripheral surface of the male member, thereby disengageably locking the male member in the female member.

Among this type of pipe couplings is one that was developed to facilitate the installation of the locking elements in the female member (see Patent Document 1). More specifically, the female member is formed from a tubular female member body and a sleeve inserted therein. The sleeve is designed to retain the locking elements. Thus, the locking elements can be installed by inserting the sleeve, which retains the locking elements, into the female member body.

The sleeve of the above-described pipe coupling has a plurality of first slits for retaining locking elements. The first slits are spaced at predetermined intervals in the circumferential direction of the sleeve and extend rearward from the forward end of the sleeve. The locking elements are received into the first slits from radially outside of the sleeve and engaged with both side walls of the first slits so as to be slidable along the first slits. To install the sleeve in the female member body, the locking elements are engaged and retained in the first slits, and thereafter, the sleeve is inserted into the female member body. When the sleeve is inserted as far as a predetermined position, an engaging portion of the sleeve is engaged with an engaging portion formed on the inner wall surface of the female member body, thereby preventing the sleeve from coming out of the female member body. The locking elements are clamped between the outer peripheral surface of the male member inserted into the female member and a tapered inner peripheral surface of the female member, thereby locking the male member to the female member.

### Patent Document 1: Japanese Patent No. 3,319,712

### DISCLOSURE OF THE INVENTION

### Problem to be Solved by the Invention

In the above-described pipe coupling, the wall of the sleeve that is provided with the first slits has an increased thickness at a portion thereof provided with the engaging portion of the sleeve, which is engaged with the engaging portion of the inner wall surface of the female member body, to achieve structural reinforcement. The first slits extend from the forward end of the sleeve to the thick-walled portion. In addition, second slits are each provided at a circumferentially intermediate position between each pair of adjacent first slits. The second slits extend longer than the first slits. Thus, when the sleeve is inserted into the female member body, the thick-walled portion with an increased diameter readily deflects radially inward as it passes along the inner wall portion of the pipe coupling provided with the engaging portion and having a reduced inner diameter.

With the above-described pipe coupling, if the pressure of a fluid to be handled increases, it becomes necessary to provide a correspondingly increased number of locking elements. Under these circumstances, we attempted to also use the second slits to retain locking elements. We found, however, that if the second slits are also used to retain locking elements, the sleeve cannot satisfactorily contract when it is passed through the small-diameter portion of the inner wall surface of the female member body because the locking elements are present in all the first and second slits. Thus, the sleeve cannot be smoothly inserted into the female member body.

The present invention has been made in view of the above-described circumstances. An object of the present invention is to allow all slits to retain locking elements without interfering with the insertion of the sleeve into the female member body.

### Means for Solving the Problem

That is, the present invention provides a male-female member assembly including a female member (denoted by reference numeral 12 in the following description of embodiments) and a male member (14) that is inserted into and connected to the female member. The female member (12) includes a tubular female member body (22) having a receiving bore (20) for receiving the male member. Locking elements (24) are installed in the receiving bore (20). The locking elements (24) engage the male member (14) inserted into the receiving bore to lock it in the receiving bore. The female member (12) further includes a tubular locking element retaining member (26) concentrically inserted and installed in the receiving bore (20) to retain the locking elements (24). The inner peripheral surface of the receiving bore (20) has, in order from an opening end portion for receiving the male member (14) to the inner side in the axial direction of the female member body (22), an entrance opening surface (28) extending in the axial direction, a first engaging surface (30) extending in the radial direction, and a locking element engaging surface (32) extending in the axial direction. The first engaging surface (30) has an inner diameter not smaller than the smallest diameter of the entrance opening surface (28) and an outer diameter larger than the inner diameter thereof. The locking element engaging surface (32) is sloped so that the diameter thereof increases as the distance from the outer end thereof increases toward the inner side in the axial direction.

The locking element retaining member (26) has on the outer peripheral surface thereof a second engaging surface (34) extending radially outward. The second engaging surface (34) is engaged with the first engaging surface (30) when the locking element retaining member (26) is inserted into the receiving bore to hold the locking element retaining member (26) in the receiving bore (20) against a force applied to the locking element retaining member (26) to pull it out of the receiving bore (20).

The locking element retaining member (26) further has a plurality of circumferentially spaced locking element retaining slits (36) extending rearward from the forward end in the direction of insertion of the locking element retaining member into the receiving bore (20) to the neighborhood of the position of the second engaging surface (34). The locking element retaining slits (36) form cantilever beam portions between each pair of adjacent locking element retaining slits (36). The beam portions extend from the position near the second engaging surface (34) to the forward end of the locking element retaining member.

Among the plurality of locking element retaining slits (36), desired locking element retaining slits (36) each receive one of the locking elements from radially outside. The locking element is engaged and retained with both side wall surfaces (56) of the locking element retaining slit in such a manner that the locking element partially projects radially inward from the inner peripheral surface of the locking element retaining member (26).

When the male member (14) is inserted into the locking element retaining member (26), the locking elements (24) are engaged with the male member (14) and displaced radially outward so as to be clamped between the locking element engaging surface (32) and the male member (14), thereby holding the male member (14) in the receiving bore.

The locking element retaining slits (36) are configured to retain the locking elements (24) in such a manner as not to interfere with the displacement of the beam portions that are displaced radially inward as a portion of the locking element retaining member (26) around the second engaging surface (34) is engaged with the entrance opening surface (28) when the locking element retaining member (26) is inserted and installed into the receiving bore (20), to a radial position adequate for the portion of the locking element retaining member (26) around the second engaging surface (34) to pass inside the entrance opening surface (28).

That is, in this male-female member assembly, the locking elements (24) are retained in such a manner as not to interfere with the radially inward displacement of the beam portions of the locking element retaining member (26), thereby allowing insertion of the locking element retaining member into the receiving bore of the female member. It should be noted that the terms “extending in the axial direction” and “extending in the radial direction” as used the phrases “an entrance opening surface extending in the axial direction” and “a first engaging surface extending in the radial direction” need not necessarily be construed limitatively as being parallel or perpendicular to the axial direction, as will be understood from the definition that “the locking element engaging surface is sloped so that the diameter thereof increases as the distance from the outer end thereof increases toward the inner side in the axial direction.

Specifically, the locking element retaining slits (36) may be arranged to retain the locking elements (24) in such a manner that the locking elements (24) are not engaged with the entrance opening surface (28) when the locking element retaining member is inserted and installed into the receiving bore.

More specifically, the arrangement may be such that the radially outermost portions (58) of the locking elements (24) with respect to the axis of the locking element retaining member when the locking elements (24) are received in the locking element retaining slits (36) are at a radial position where the radially outermost portions (58) pass radially inside the entrance opening surface (28) of the female member body when the locking element retaining member is inserted and installed into the female member body.

That is, in this male-female member assembly, when the locking element retaining member is inserted into the receiving bore, the locking elements are prevented from engaging the entrance opening surface of the receiving bore, which has a small diameter. Therefore, when the beam portions between the slits of the locking element retaining member deflect inward as the locking element retaining member is passed through the entrance opening surface, the locking elements are not pressed from radially outside, and hence there is no resistance to the deflection from the locking elements. Accordingly, the locking element retaining member can be inserted smoothly.

In addition, the locking element retaining slits may retain the locking elements, respectively. Because the retention of the locking elements by the locking element retaining slits is performed as stated above, all the slits can retain the locking elements.

### ADVANTAGEOUS EFFECTS OF THE INVENTION

The male-female member assembly according to the present invention, which is arranged as stated above, enables the locking elements to be installed in all the slits formed on the locking element retaining member. If the male-female member assembly is applied to a pipe coupling, for example, it is possible to increase the holding force with which the male member is held by the locking elements without increasing the overall size of the pipe coupling in comparison to the above-described conventional pipe couplings. Accordingly, it becomes possible to handle a fluid at a higher pressure than with the conventional pipe couplings. In a case where the male-female member assembly is used in a pipe coupling that handles a low-pressure fluid, the number of locking elements used may be reduced. Therefore, it is possible with a pipe coupling of one size to handle fluids over a wide range of pressures, from low pressure to high pressure, in comparison to the conventional pipe couplings.

In a case where the male-female member assembly according to the present invention is used as a device for fastening a panel or the like, it is also possible to adjust the holding force according to the weight of an object to be fastened, e.g. a panel, in the same way as the above-described pipe coupling.

### BRIEF DESCRIPTION OF THE DRAWINGS

FIG. 1 is a view of a male-female member assembly according to the present invention produced in the form of a holder for holding a plate or the like on a wall, showing a state where a male member is inserted in and connected to a female member, in which an upper half of the holder is shown in a sectional view.

FIG. 2 is a view showing a state before the male member of the holder is inserted into the female member.

FIG. 3 is a longitudinal sectional view of a locking element retaining member in the holder.

FIG. 4 is a left end view of the holder shown in FIG. 3.

FIG. 5 is a view of the male-female member assembly according to the present invention as applied to a pipe coupling, showing a state before the male member is connected to the female member, in which an upper half of the pipe coupling is shown in a sectional view.

### BEST MODE FOR CARRYING OUT THE INVENTION

Embodiments of the male-female member assembly according to the present invention will be explained below.

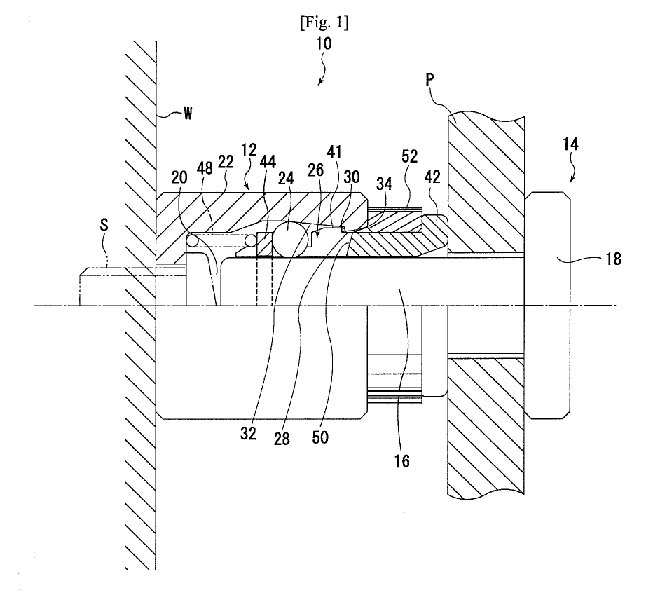

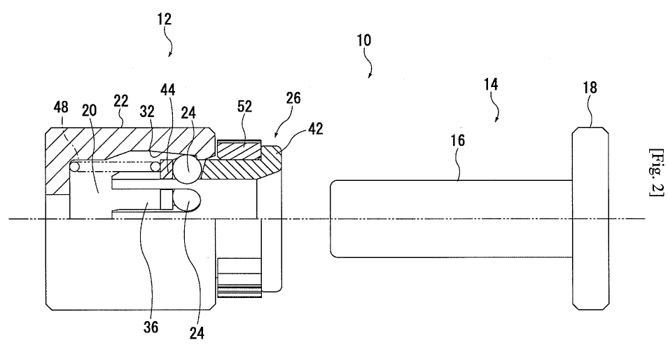

FIGS. 1 and 2 show an embodiment of the male-female member assembly according to the present invention in which the invention is embodied as a fastening device 10.

As shown in FIG. 1, the fastening device 10 includes a female member 12 fixed to a wall W with a screw S or the like. The fastening device 10 further includes a male member 14 that is inserted into and connected to the female member 12 to fasten a panel P.

The male member 14 has a shaft-shaped connecting portion 16 to be inserted into the female member 12 and a head portion 18 attached to one end of the connecting portion 16.

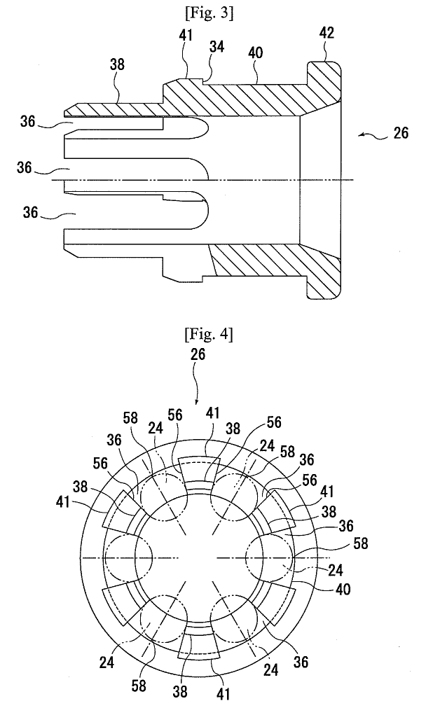

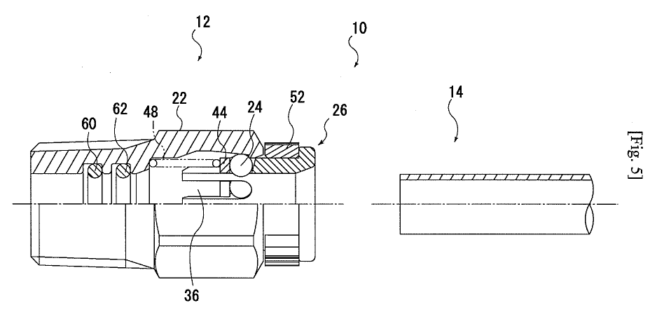

The female member 12 includes a tubular female member body 22 having a receiving bore 20 for receiving the male member 14, and spherical locking elements 24 installed in the receiving bore 20. The locking elements 24 engage the connecting portion 16 of the male member 14 inserted into the receiving bore to lock the male member 14 in the female member 12. The female member 12 further includes a tubular locking element retaining member 26 concentrically inserted and installed in the receiving bore 20 to retain the locking elements 24 (see FIGS. 3 and 4).

The receiving bore 20 has, in order from the opening end thereof to the inner side in the axial direction, an entrance opening surface 28 extending in the axial direction, a first engaging surface 30 extending in the radial direction, and a locking element engaging surface 32 extending in the axial direction. The entrance opening surface 28 has a sloped portion having a diameter decreasing as the distance from the opening end increases in the axial direction. The entrance opening surface 28 further has a parallel portion contiguous with the sloped portion and extending parallel to the axis. The first engaging surface 30 extends radially outward from the axially inner end of the parallel portion of the entrance opening surface 28. The locking element engaging surface 32 is sloped so that the diameter thereof increases as the distance from the outer end thereof increases toward the inner side in the axial direction.

The locking element engaging surface 32 engages the locking elements 24 that are engaged with the connecting portion 16 of the male member 14 when inserted into the receiving bore 20 and that are displaced radially outward. The locking element engaging surface 32 clamps the locking elements 24 between itself and the connecting portion 16 of the male member 14, thereby holding the male member 14 in the receiving bore.

The locking element retaining member 26 has on the outer peripheral surface thereof a second engaging surface 34 having a third diameter. The second engaging surface 34 is engaged with the first engaging surface 30 when the locking element retaining member 26 is inserted into the receiving bore 20 to hold the locking element retaining member 26 in the receiving bore 20 against a force applied to the locking element retaining member 26 to pull it out of the receiving bore 20.

The locking element retaining member 26 further has a plurality of circumferentially spaced locking element retaining slits 36 extending rearward from the forward end of the locking element retaining member 26 as viewed in the direction of insertion thereof into the receiving bore 20 (i.e. the left end as seen in the figures) to the neighborhood of the position of the second engaging surface 34. Each locking element retaining slit 36 receives one locking element 24 from radially outside. The locking element 24 is engaged and retained with both side wall surfaces 56 of the slit 36. When the locking element 24 is in this state, the radially inner portion thereof projects more inward than the slit 36 (FIG. 2). When the connecting portion 16 of the male member 14 is inserted, the locking element 24 is first engaged with the forward end of the connecting portion 16 and pushed forward, thereby being displaced radially outward along the sloped locking element engaging surface 32 while being displaced along the slit 36. When the locking element 24 has been displaced through a predetermined distance, the forward end of the connecting portion 16 disengages from the locking element 24 and is inserted deep into the receiving bore 20 as shown in FIG. 1. The locking element 24 is urged rightward as seen in FIG. 1 by a ring 44, which is urged by a spring (described later). Thus, the locking element 24 is engaged with the locking element engaging surface 32 and thereby pressed against the outer peripheral surface of the connecting portion 16 of the male member 14 to lock the male member 14.

As shown particularly clearly in FIG. 3, the locking element retaining member 26 has, in order from the forward end thereof, a thin-walled portion 38, a thick-walled portion 40, and a flange portion 42 at the rear end thereof. A stepped portion 41 is formed at the forward end of the thick-walled portion 40. The rear end surface of the stepped portion 41 is the second engaging surface 34. The locking element retaining slits 36 extend approximately as far as the position of the second engaging surface 34, thereby allowing the stepped portion 41 to readily deflect radially inward as it passes along the entrance opening surface 28, which has a smaller diameter than that of the stepped portion 41, when the locking element retaining member 26 is inserted and installed into the female member 12. The thick-walled portion 40 has, as shown in FIG. 1, a diameter substantially the same as, but slightly smaller than, that of the entrance opening surface 28 of the female member body.

A ring 44 is axially slidably provided around the thin-walled portion 38 of the locking element retaining member 26. The ring is urged toward the locking elements 24 by a coil spring 48 installed in the receiving bore 20. Consequently, when the male member 14 is not inserted in the female member 12, as shown in FIG. 2, the locking elements 24 are pressed against respective innermost tapered surfaces 50 of the locking element retaining slits 36. Accordingly, in this state, the locking elements 24 are displaced slightly more radially outward than in the case of being engaged in the locking element retaining slits 36 in a free state.

As shown in FIGS. 1 and 2, a lock ring 52 is fitted between the flange portion 42 of the locking element retaining member 26 inserted in the female member 12 and the end surface of the female member body 22 to lock the locking element retaining member 26 so as to prevent the locking element retaining member 26 from moving relative to the female member body 22. The lock ring 52 is a slit ring, which can be removed by opening it. When the male member 14 is to be disengaged from the female member 12, the lock ring 52 is removed by opening it, and the locking element retaining member 26 is pushed further inside of the female member body 22, causing the locking elements 24 to be displaced to the side of the locking element engaging surface 32 toward which the inner diameter thereof increases, thereby canceling the pressing force of engagement of the locking elements 24 with the male member 14, and thus allowing the male member 14 to be removed from the female member 12.

As shown in FIG. 4, when the locking elements 24 are received in the locking element retaining slits 36 from radially outside, they are engaged and retained with side wall surfaces 56 of the slits 36. When the locking elements 24 are retained in the locking element retaining slits 36, the radially outermost portions 58 of the outer peripheral surfaces of the locking elements 24, with respect to the center of the locking element retaining member 26, are positioned on the prolongation of the outer peripheral surface of the thick-walled portion 40 or closer to the center of the locking element retaining member 26 than the prolongation. With this arrangement, the locking elements 24 are prevented from engaging the entrance opening surface 28 when the locking element retaining member 26 is inserted into the female member body 22 in a state where the locking elements 24 are placed in the slits 36.

That is, the inventor of this application attempted to design such that locking elements are provided in all slits provided in the sleeve (equivalent to the locking element retaining member in the present invention) of the pipe coupling disclosed in Patent Document 1, as has been stated above in the section entitled “Background Art”. We found, however, that if locking elements are provided in all the slits, the sleeve cannot satisfactorily contract radially inward when it is passed through the receiving opening of the female member body so as to be inserted and installed in the female member body; therefore, it is difficult to insert the sleeve into the female member body. The reason for this was found to be that the locking elements, which are provided in all the slits, interfere with the contractive deformation of the sleeve. We could not readily find a way to resolve the problem and conducted various studies. As a result, we found that the problem can be resolved by positioning the radially outermost portions 58 of the outer peripheral surfaces of the locking elements 24 on the prolongation of the outer peripheral surface of the thick-walled portion 40 or closer to the center of the locking element retaining member 26 than the prolongation, as stated above, i.e. by preventing the locking elements 24 from engaging the entrance opening surface 28 when the locking element retaining member 26 is inserted into the female member body 22 in a state where the locking elements 24 are placed in the slits 36. In other words, the locking elements 24 are prevented from engaging the entrance opening surface 28 of the female member body and thus prevented from applying any resistance to the locking element retaining member 26 when contracting radially inward (and hence reducing the slit width and causing the locking elements to be displaced radially outward).

FIG. 5 shows a state before the male member is connected to the female member in a case where the male-female member assembly according to the present invention as applied to a pipe coupling. The basic arrangement of the pipe coupling is the same as that of the above-described fastening device except that two O-rings 60 and 62 are provided in the pipe coupling. Therefore, members of the pipe coupling that have similar functions to those of the fastening device are denoted by the same reference numerals, and a detailed description thereof is omitted.

Although some embodiments of the male-female member assembly according to the present invention have been described above, the present invention is not necessarily limited to the described embodiments. For example, in the foregoing embodiments, the locking elements 24 are prevented from engaging the entrance opening surface 28 when the male member is inserted into the receiving bore of the female member. The locking elements 24 may, however, engage the entrance opening surface 28 to some extent. For example, it is possible to enable the locking element retaining member to enter the receiving bore without being substantially interfered with by the locking elements by appropriately selecting a material for the locking element retaining member, particularly the peripheral portion thereof that retains the locking elements. This can also be achieved by appropriately selecting a material for the locking elements.

1. A male-female member assembly comprising a female member and a male member that is inserted into and connected to the female member;
the female member comprising:
a tubular female member body having a receiving bore for receiving the male member;
locking elements disposed in the receiving bore, the locking elements being engageable with the male member inserted into the receiving bore to lock it in the receiving bore; and
a tubular locking element retaining member concentrically inserted and disposed in the receiving bore to retain the locking elements;
wherein an inner peripheral surface of the receiving bore has, in order from an opening end portion for receiving the male member to an inner side in an axial direction of the female member body, an entrance opening surface extending in the axial direction, a first engaging surface extending in a radial direction, and a locking element engaging surface extending in the axial direction, the first engaging surface having an inner diameter not smaller than a smallest diameter of the entrance opening surface and an outer diameter larger than the inner diameter, the locking element engaging surface being sloped so that its diameter increases as a distance from an outer end thereof increases toward the inner side in the axial direction;
wherein the locking element retaining member includes an outer peripheral surface having a second engaging surface extending outward radially, the second engaging surface being engaged with the first engaging surface when the locking element retaining member is inserted into the receiving bore to hold the locking element retaining member in the receiving bore against a force applied to the locking element retaining member to pull it out of the receiving bore;
wherein the locking element retaining member further has a plurality of circumferentially spaced locking element retaining slits extending rearward from a forward end in a direction of insertion of the locking element retaining member into the receiving bore to a neighborhood of a position of the second engaging surface, the locking element retaining slits forming cantilever beam portions between each pair of adjacent locking element retaining slits, the beam portions extending from a position near the second engaging surface to the forward end of the locking element retaining member;
wherein the locking element retaining slits each receive one of the locking elements from radially outside, the locking element being engaged and retained with both side wall surfaces of the locking element retaining slit in such a manner that the locking element partially projects radially inward from an inner peripheral surface of the locking element retaining member;
wherein when the male member is inserted into the locking element retaining member, the locking elements are engaged with the male member and displaced radially outward so as to be clamped between the locking element engaging surface and the male member, thereby holding the male member in the receiving bore; and
wherein the locking element retaining slits are configured to retain the locking elements in such a manner as not to interfere with displacement of the beam portions, which are displaced radially inward as a portion of the locking element retaining member around the second engaging surface is engaged with the entrance opening surface when the locking element retaining member is inserted and installed into the receiving bore, to a radial position adequate for the portion of the locking element retaining member around the second engaging surface to pass inside the entrance opening surface.

2. A male-female member assembly according to claim 1, wherein the locking element retaining slits are configured to retain the locking elements in such a manner that the locking elements do not engage the entrance opening surface when the locking element retaining member is inserted and installed into the receiving bore.

3. A male-female member assembly according to claim 1, wherein radially outermost portions of the locking elements with respect to an axis of the locking element retaining member when the locking elements are received in the locking element retaining slits are positioned where the radially outermost portions pass radially inside the entrance opening surface of the female member body when the locking element retaining member is inserted and installed into the female member body.

4. A male-female member assembly according to claim 1, wherein the locking element retaining slits are configured to retain the locking elements, respectively.
